(19) United States
(12) Patent Application Publication
(10) Pub. No.: US 2005/0282962 A1
(43) Pub. Date: Dec. 22, 2005

(54) Pigmentation of ionomers

(75) Inventors: Dennis C. Smith, Norwalk, OH (US); Mark A. Tyler, West Salem, OH (US); Heather L. Scaglione, Brunswick, OH (US)

Correspondence Address: Michael R. Asam, Esq.;Jones Day, 901 Lakeside Avenue/North Point, Cleveland, OH, 44114, US

(73) Assignee: A. Schulman, Inc.

(21) Appl. No.: 11/155,361

(22) Filed: Jun. 17, 2005

Related U.S. Application Data
(60) Provisional application No. 60/580,470, filed on Jun. 17, 2004.
(60) Provisional application No. 60/585,415, filed on Jul. 2, 2004.

(51) Int. Cl. C08F 8/00

(52) U.S. Cl. 525/191

(57) ABSTRACT

Pigment pre-dispersions for use with ionomers, methods for making pigment pre-dispersions for use with ionomers, pigmented ionomers, and multilayer films containing pigmented ionomers are disclosed. The pigment pre-dispersions generate or maintain a minimal pigment particle size in order to optimize the dispersability of the pigment in an ionomer upon a single pass through processing equipment. The carrier of the pigment pre-dispersion is chosen based on compatibility parameters, such as refractive index and viscosity, to be compatible with the ionomer. Carriers can include acid copolymers, acid terpolymers, ionomers, polyethylenes, ethylene vinyl acetate, and ethylene methacrylate. The pigmented ionomers created from these pigment pre-dispersions have well dispersed pigment with a particle size of less than or equal to about 25 micrometers. Films or sheets can be created from the pigmented ionomers and the pigmented ionomers can be used in mulitlayer films.

### RELATED APPLICATIONS

This application claims priority to U.S. Provisional Application Ser. No. 60/580,470, filed Jun. 17, 2004; U.S. Provisional Application Ser. No. 60/531,707, filed Jun. 17, 2004; and U.S. Provisional Application Ser. No. 60/585,415, filed Jul. 2, 2004, each of which is hereby incorporated by reference.

### FIELD

Compositions and methods for the pigmentation of ionomers, pigmented ionomers, and multilayer films containing pigmented ionomers.

### BACKGROUND

Pigment can be added to a polymer as the polymer is mixed in a mixer or extruder. However, this does not typically provide optimal dispersion of the pigment throughout the polymer upon one pass through processing equipment. One way in which to improve dispersion is to add a dispersant aid. Some examples of dispersant aids are waxes and other low molecular weight carriers. When a wax is used as the dispersant aid, the wax and pigment are pre-blended to form a “pre-dispersion” that is added to the polymer when the polymer is mixed. A similar process is used for other low molecular weight carriers. Pre-dispersions based on wax and other low molecular weight carriers, however, are not always compatible with ionomers due to the charged regions of the ionomer molecules and other intermolecular interactions. In the case of wax carriers, among other compatibility problems, the wax often migrates to the surface of the finished part over time, adversely impacting the surface appearance.

### SUMMARY

A method for making a pigment pre-dispersion composition for use with an ionomer comprises several steps. One step is to create a slurry of a pigment in water. Another step is to melt or soften a resin compatible with an ionomer. A further step is to mix the slurry into the melted or softened resin. The slurry can have a pigment particle size of less than or equal to about 50 micrometers. The pigment pre-dispersion can have a pigment particle size of less than about 30 micrometers. The refractive index of the resin that is compatible with an ionomer can have a refractive index within about 0.005 of the refractive index of the ionomer. The melt flow index of the resin that is compatible with the ionomer can have a melt flow index that is greater than the ionomer. Examples of resins that are compatible with ionomers include, but are not limited to, acid copolymer, acid terpolymer, ionomer, polyethylene, ethylene vinyl acetate, ethylene methylacrylate, and mixtures thereof.

A pigment pre-dispersion composition for use with an ionomer can comprise several components. One component can be a resin that is compatible with an ionomer. Another component can be a pigment having a particle size that is less than about 30 micrometers. The refractive index of the resin that is compatible with an ionomer can have a refractive index within about 0.005 of the refractive index of the ionomer. The melt flow index of the resin that is compatible with the ionomer can have a melt flow index that is greater than the ionomer. Examples of resins that are compatible with ionomers include, but are not limited to, acid copolymer, acid terpolymer, ionomer, polyethylene, ethylene vinyl acetate, ethylene methylacrylate, and mixtures thereof.

A melt blended composition can comprise several components. One component can be an ionomer. Another component can be a resin that is compatible with the ionomer. Another component can be a pigment having a pigment particle size that is less than or equal to about 25 micrometers. The refractive index of the resin that is compatible with an ionomer can have a refractive index within about 0.005 of the refractive index of the ionomer. The melt flow index of the resin that is compatible with the ionomer can have a melt flow index that is greater than the ionomer. Examples of resins that are compatible with ionomers include, but are not limited to, acid copolymer, acid terpolymer, ionomer, polyethylene, ethylene vinyl acetate, ethylene methylacrylate, and mixtures thereof. The melt blended composition can be formed into a film or sheet.

A mulitlayer film or sheet can comprise a polymer layer and a pigmented ionomer layer. The pigmented ionomer layer can comprise several components. One component can be an ionomer. Another component can be a resin that is compatible with the ionomer. Another component can be a pigment having a pigment particle size that is less than or equal to about 25 micrometers. The refractive index of the resin that is compatible with an ionomer can have a refractive index within about 0.005 of the refractive index of the ionomer. The melt flow index of the resin that is compatible with the ionomer can have a melt flow index that is greater than the ionomer. Examples of resins that are compatible with ionomers include, but are not limited to, acid copolymer, acid terpolymer, ionomer, polyethylene, ethylene vinyl acetate, ethylene methylacrylate, and mixtures thereof.

### BRIEF DESCRIPTION OF THE DRAWINGS

FIG. 1 is a cross-sectional view of a two-layer film.

FIG. 2 is a cross-sectional view of a three-layer film.

FIG. 3 is a cross-sectional view of a four-layer film.

### DETAILED DESCRIPTION

As examples of how a person of ordinary skill in the art can make and use the claimed invention, this description presents examples of pigment pre-dispersions for use with ionomers, methods for making pigment pre-dispersions for use with ionomers, pigmented ionomers, and multilayer films containing pigmented ionomers. This description is provided to meet the requirements of enablement and best mode without imposing limitations that are not recited in the claims. As used herein, the term pigment pre-dispersion means a pigment mixed into a carrier that will in turn be mixed into a polymer to be pigmented during processing. The pigment pre-dispersions provide pigments that disperse well within an ionomer during the first pass of the ionomer through processing equipment. The pigment pre-dispersions disperse well, e.g., release well, because the pigment particle size is minimized during the process of making the pigment pre-dispersion.

A minimal pigment particle size enables the pigment to be more easily dispersed during the limited amount of time the ionomer spends in the processing equipment. Further, the pigment carrier in the pre-dispersions is a polymer resin (carrier resin) that is selected based on its ability to mix well with the ionomer and not negatively affect the ionomer properties during or after processing. Minimizing the pigment particle size and selecting a carrier resin that is compatible with the ionomer allows for the optimization of pigment dispersion in the ionomer in a single pass through processing equipment.

Each pigment pre-dispersion comprises a carrier resin that is compatible with an ionomer and a pigment. In these pigment pre-dispersions, the pigment is dispersed within the carrier resin. Pigments compatible with the pigment pre-dispersions disclosed herein include organic and inorganic pigments. Examples of the types of pigments that can be included in such a pigment pre-dispersion include, but are not limited to, carbon black, titanium dioxide, zinc oxide, calcium carbonate, black iron oxide, red iron oxide, yellow iron oxide, green iron oxide, mixed metal oxides, bismuth vanadate, phthalocyanine blue, phthalocyanine green, Quinacridone reds, anthraquinone, perylene reds, polyazos, or mixtures thereof. Generally, organic pigments are smaller and more difficult to disperse than inorganic pigments. Examples of resins compatible with ionomers for use in the claimed pigment pre-dispersions include, but are not limited to, acid copolymers, acid terpolymers, ionomers, polyethylenes, ethylene vinyl acetate, and ethylene methacrylate.

lonomers useful with the claimed invention include, but are not limited to, copolymers of ethylene and α, β-ethenically unsaturated C₃-C₈ carboxylic acid; and terpolymers of ethylene, α, β-ethenically unsaturated C₃-C₈ carboxylic acid, and acrylate. The average acid of such copolymers prior to neutralization can be between about 9 to about 15 percent. These copolymers can be neutralized or partially neutralized by metal ions such as, for example, zinc, sodium, magnesium, or lithium ions. The highest levels of scratch resistance and gloss for these copolymers are noted when the level of neutralization is high. The highest level mar resistance coupled with good processability for products manufactured from these copolymers is found when the copolymers are neutralized at a level between about 50 to about 90 percent.

Many factors can affect the choice of a carrier resin for use in a pigment pre-dispersion. Specifically at issue is the compatibility of a carrier resin with the ionomer into which it will be blended. An example of a physical property that might affect the compatibility of a carrier resin with an ionomer is the refractive index of both materials. The refractive index of a carrier resin compatible with an ionomer may be very close to the refractive index of the ionomer, e.g., within 0.005 of the refractive index of the ionomer (sodium-D filter at 20° C.). The refractive index of most ionomers is close to 1.51 (sodium-D filter at 20° C.), so the refractive index of a carrier resin can be, for example, between about 1.505 and about 1.515. In addition to having a compatible refractive index, a good choice for a carrier resin will be a carrier resin that is otherwise compatible and miscible with the ionomer into which it will be blended. The more compatible a carrier resin is with a particular ionomer, the greater the reduction can be in the formation of gels which detract from the appearance of final products.

Another factor that might be considered in the choice of a carrier resin is the viscosity of the carrier resin as compared to the viscosity of the ionomer. Differences in viscosity between the carrier resin and ionomer can cause non-uniform distribution of the pigment. A useful measurement indicating viscosity is melt flow rate, which may be measured, for example, according to ASTM D1238. Typically, the melt flow rate of a carrier resin compatible with a particular ionomer will be greater than the melt flow rate of the ionomer when measured at the same temperature and load as the ionomer. For example, if the melt flow index of an ionomer is about 1 g/10 min. then the melt flow index of a compatible carrier resin will be greater than about 1 g/10 min when measured at the same temperature and load as the ionomer. The carrier resin in this example may have a viscosity between about 5 g/10 min. and about 10 g/10 min.

Pigment particle size should generally be minimized for any particular pigment selected. However, as different pigments are unique compounds having widely varying sizes and molecular properties, there is no single size that can be suggested as optimal. Generally, the quality of the dispersion achieved upon mixing a pigment pre-dispersion with an ionomer will be improved the smaller the pigment particles happen to be. Typically, pigment particle sizes in a pigment pre-dispersion of less than or equal to about 25 micrometers are capable of being well dispersed.

To make a pigment pre-dispersion, first a pigment slurry is created in water. The water used to create the slurry could be modified with alcohol. The pigment added to the water can be dry powder, or can be in a form that already contains water. Next, a carrier resin compatible with an intended ionomer is melted or softened. Once the carrier resin is melted or softened, the slurry is mixed into the carrier resin to create the pigment pre-dispersion. The pigment pre-dispersion is then solidified by cooling and the solidified pigment pre-dispersion is ground. When the pigment pre-dispersion has been ground, it can be rinsed with water to remove any impurities or salts that might be formed during processing or that might have already been present in the pigment or carrier resin. The pigment pre-dispersion can be rinsed multiple times in order to remove impurities if necessary. One way that the rinse process can be monitored is to measure the conductivity of the rinse water, which would indicate the presence (or absence) of salts or other ionic species. Once the pigment pre-dispersion has been satisfactorily rinsed, the pigment pre-dispersion is then dried. As with pigment pre-dispersions that are known in the prior art, the pigment pre-dispersions prepared by the claimed method may be called monos (if a single pigment is used), concentrates (if a blend of pigments is used), or flushes (if the pigment pre-dispersion is created by dispersing pigment from an aqueous phase into a carrier resin using high shear).

To create a slurry used in making the pigment pre-dispersion just described, pigment and water are charged into a mixer. Mixers capable of generating high shear are preferred. An example of such a mixer is a Silverson Laboratory Mixer (Silverson Machines Inc., East Longmeadow, Mass.). A Silverson Laboratory Mixer is a high shear rotor/stator laboratory mixer that is capable of generating a multi-stage mixing/shearing action as materials are drawn through a specially designed workhead. The choice of material used to make the tank in which mixing occurs can be important when working with pigments especially when the pigments will be mixed with charged polymers such as ionomers. If the tank material is capable of donating ions, these ions can interact with the pigment and eventually the charged polymer. Mixing tanks such as those made from iron, for example, have free ions that can interact with the pigments and eventually the charged polymer. Mixing tanks such as those made from stainless steel, for example, do not have free ions that can interact with pigments or such ions are minimized.

Dispersing aids, processing aids, secondary processing aids, and stabilizers can be added to the slurry during preparation. Examples of stabilizers may include, but are not limited to, secondary phosphites, secondary phosphonites, antioxidants, UV stabilizers, and hindered amine stabilizers. Plasticizers may also be added, for example, as a processing aid to reduce the viscosity of the carrier resin. Secondary processing aids include materials and compounds that aid, for example, the ability to remove parts from molds or act to improve the surface hardness of the part. Examples of secondary processing aids are fatty acid amid slip masterbatchs, including primary, secondary, and secondary-bis amides. These amides can include, but are not limited to, erucamide, behenamide, and oleyl palmitate. The dispersing aids, processing aids, secondary processing aids, and stabilizers can also be added to the melted or softened carrier resin seperately from the slurry.

The quality of the pigment dispersion created during mixing, i.e., the fineness of the pigment particles, can be examined by using a Hegman gauge or by examining a portion of the slurry under a microscope. A Hegman gauge can be used to determine the fineness of grind for pigments in liquid paints, inks, or, in this case, pigment slurries. A Hegman gauge consists of a block, usually a steel block, into which a groove is cut. The groove is uniformly tapered along its length, for example, tapering from about 100.6 micrometers at one end to zero micrometers at the other (other sizes available). A scale runs along the side of the groove to indicate the groove depth. To use the gauge, a sample is placed in the groove at the deep end and a blade is used to draw liquid down the length of the groove. The point along the gauge at which the groove becomes shallow enough for pigment particles to protrude above the level of the liquid is the particle size. The point at which pigment particles protrude above the level of the liquid is typically observed by viewing the gauge at an angle. The scale typically used with a Hegman gauge is called the Northern Standard Scale and varies from 8 to 0. An approximate correlation of the North Standard Scale with micrometer sizes is shown in Table 1.

TABLE 1
North Standard Scale vs. Micrometers

| North | |
|---|---|
| Standard Scale | Micrometers |
| 0 | 100.6 |
| 1 | 88.9 |
| 2 | 76.2 |
| 3 | 63.5 |
| 4 | 50.8 |
| 5 | 38.1 |
| 6 | 25.4 |
| 7 | 12.7 |
| 8 | 0 |

The level of fineness of pigment particles in a pigment slurry compatible with the claimed pigment pre-dispersions is greater than or equal to about 4 on the North Standard Scale. Additional compatible fineness levels in a pigment slurry include particles sized greater than or equal to about 5 on the North Standard Scale, particles sized greater than or equal to about 6 on the North Standard Scale, and particles sized greater than or equal to about 7 on the North Standard Scale.

A microscope can also be used to examine the fineness of the pigment particles in the slurry. To use a microscope to examine the fineness of pigment particles in a slurry, a portion of the slurry is spread on a slide. The slurry is then viewed under a level of magnification capable of resolving individual pigment particles. The size of the pigment particles can be determined by using a scale internal to the microscope, e.g., a graduated reticule. In micrometers, the fineness of pigment particles in a pigment slurry is less or equal to about 50 micrometers. Additional compatible fineness of pigment particles in a pigment slurry include particles sized less than or equal to about 40 micrometers, particles sized less than or equal to about 30 micrometers, particles sized less than or equal to about 20 micrometers, and particles sized less than or equal to about 10 micrometers.

Care can be taken during the grinding step for making a pigment pre-dispersion in order to avoid melting and reagglomerating the material being ground. Specifically, if the temperature rises too much during grinding, the resin can melt thereby allowing the ground particles to reagglomerate. Controlling the temperature during the grinding step can help avoid reagglomeration. There may be a lower limit to the temperature of the material being ground based on the grinding apparatus. Specifically, the torque limits of the grinder might be exceeded if the temperature of the pigment pre-dispersion being ground is too low and the pigment pre-dispersion is too hard. One way to help control the temperature during the grinding stage is, for example, to add water to the material in the grinder.

Care also can be taken during the drying step in order to avoid melting and potentially reagglomerating the material that was just ground and rinsed. Specifically, if the temperature of the dryer is too high, the resin of the pigment pre-dispersion can melt and agglomerate with similarly melted pigment pre-dispersion pieces. Controlling the temperature of the pigment pre-dispersion during drying can be accomplished by adding, for example, dry ice to the pigment pre-dispersion material in the dryer.

The step of melting or softening the carrier resin involves simply applying heat to the carrier resin in an appropriate manner to melt or soften the carrier resin in a controlled, non-destructive manner. Often, the step of melting or softening the carrier resin will occur in the device in which the pigment slurry will be mixed with the carrier.

Mixing a pigment slurry into a melted or softened resin can occur in any of the many different types of mixers capable of generating high shear or otherwise thoroughly dispersing the pigment particles through the carrier resin. Examples of these types of mixers include, but are not limited to, fluidized bed jet mills, horizontal media mills, max-shear incline dispensers, multi-shaft mixers, and twin or single screw extruders.

Dispersion quality can be monitored, if so desired, by quantifying the size and/or frequency of agglomerates, aggregates, fish-eyes, or other features. A pigment pre-dispersion may have pigment agglomerates or aggregates that have a size that is less than or equal to about 30 micrometers. The size of the pigment agglomerates or aggregates can also be less than or equal to about 25 micrometers, less than or equal to about 20 micrometers, less than or equal to about 15 micrometers, less than or equal to about 10 micrometers, or less than or equal to about 5 micrometers. Further, suitable pigment pre-dispersions may have less than an average of a set number of pigment particles, agglomerate, or aggregate per a set volume of material.

In a pigment pre-dispersion, the dispersion quality of a pigment is difficult to measure directly due to high pigment loading levels. One way to prepare a sample that can be monitored is to let down (blend) the pigment pre-dispersion into a host resin such as, for example, an acid copolymer, an ionomer, or a blend of acid copolymer and ionomer. The level to which a pigment pre-dispersion is let down depends on the ability to differentiate individual particles under a microscope. The pigment pre-dispersion can, for example, be let down at a level of about 25% to about 50% of the let down mixture. Once let down into a host resin, the dispersion quality of the pigment pre-dispersion can be examined using a compound light microscope employing cross-polarized light. To prepare a sample for examination, a pellet or other small portion of the let down pigment pre-dispersion is melted and smeared across the surface of a microscope slide forming a thin layer. An example of a prepared sample might be approximately 6 cm long by 1.5 cm wide by 10 micrometers thick. The thickness of the layer can vary somewhat with the main criteria being that the layer be thin enough for light to pass through.

Once such a smear sample is prepared, the pigment particle size and/or frequency can be measured using a microscope. Pigment particle size can be measured using a scale internal to the microscope, e.g., a graduated reticule. The frequency of pigment particles, agglomerates, or aggregates in a pigment pre-dispersion is the average number of particles per some defined volume such as, for example, the field of view of the microscope for a known thickness.

Another way to monitor the dispersion quality of the pigment in the pigment pre-dispersion is to melt the pigment pre-dispersion and force the melted material through a screen or series of screens with defined mesh size. In this method, a quantity of pigment pre-dispersion material is melted then forced through a screen or series of screens under a constant load while the pressure across the screen is monitored. If the pigment does not contain agglomerates or aggregates that are larger than the screen mesh size, the pigment pre-dispersion will flow through the screen with no change in pressure while the entirety of the melted material flows through the screens. If there are agglomerates or aggregates that are too large to flow through the screens, then portions of the screens will become plugged and the pressure across the screens will increase. At some point, the screens may become completely clogged causing a pressure spike then the screen may break. If screen clogging agglomerates or aggregates are present, then the rate of pressure change, if any, can provide information on the concentration and a threshold indication of the size of those agglomerates or aggregates. A suitable pigment pre-dispersion when melted will flow through a screen with openings of approximately 38 micrometers (U.S. Mesh 400). Suitable pigment pre-dispersions with finer pigment particle sizes will flow through a screen with opening of approximately 25 micrometers (U.S. Mesh 500).

In each example, the pigment pre-dispersion can be simply added to an ionomer as the ionomer is processed in an apparatus such as an extruder. The pigment pre-dispersion can be pre-mixed with ionomer pellets or powder prior to the ionomer being added to the processing apparatus or the pigment pre-dispersion can be added to the processing apparatus by itself. Additionally, the pigment pre-dispersion can be let down into an intermediate carrier and this intermediate mixture can then be blended with an ionomer. The intermediate carrier can be any of the materials listed as carrier resins above. If let down into an intermediate carrier, the pigment pre-dispersion level can be, for example, about 25% to about 50% of the intermediate mixture. The intermediate mixture can then be mixed with an ionomer at a level, for example, of about 2% to about 10% of the ionomer.

The quality of a film, sheet, or other part formed from a pigmented ionomer depends, in part, on the size and the dispersion of the pigment particles within the ionomer. The pigment pre-dispersions described above minimize pigment particle size as much as is practicable while maximizing the dispersion of the pigment particles within the ionomer. By way of a reference guide, it has been determined by the inventors that agglomerations, including pigment particle agglomerates and gels, are visible to the average person as shown in Table 2.

TABLE 2
Visibility of Agglomerates at Various Distances

| | Visibility^{b} at | | |
|---|---|---|---|
| Particle Size^{a} | 2″ | 6″ | 24″ |
| 5 | no adequate resolution | not visible | not visible |
| 10 | slight imperfection/ | not visible | not visible |
| | hard to resolve | | |
| 20 | could resolve/easy to | difficult to clearly | not visible |
| | discern | resolve | |
| 20-50 | could resolve/easy to | begin to resolve/ | not visible |
| | discern | easier to discern | |
| 50-100 | could resolve/easy to | could resolve/easy | not visible |
| | discern | to discern | |
| 100-200 | could resolve/easy to | could resolve/easy | discern |
| | discern | to discern | some |
| | | | light |
| | | | scattering |
| 200-400 | could resolve/easy to | could resolve/easy | discern |
| | discern | to discern | some |
| | | | light |
| | | | scattering/ |
| | | | begin to |
| | | | resolve |
| 400-1000+ | easily resolved | easily resolved | easily |
| | | | resolved |

^{a}micrometers
^{b}Horizontal distance from surface.

As can be seen from Table 2, agglomerate sizes of 20 micrometers or less are difficult to resolve with the naked eye at greater than or equal to about 6 inches from the surface of the ionomer film, sheet or part. As a further point of reference, the average person can resolve agglomerates as small as 20 to 25 micrometers at a distance of 2 to 3 inches from the particle. These data points indicate that for most purposes as long as pigment particle size is less than or equal to about 25 micrometers the ionomer surface will have an appearance unaffected by agglomerate size (when viewed at 6 inches or greater from the surface). Pigment particle sizes of less than or equal to about 20 micrometers, less than or equal to about 15 micrometers, less than or equal to about 10 micrometers, or less than or equal to about 5 micrometers are also acceptable. If the finished ionomer part is intended to be used closer than about 6 inches from the eye of the user, then small pigment particle sizes such as about 10 micrometers or even about 5 micrometers could be used.

In progressing from a raw pigment to a pigment pre-dispersion and finally an ionomer composition, pigment particles typically pass through several discrete stages, each of which has its own pigment particle size requirements. Initially, the pigment particles exist as a powder (or similar concentrated pigment form). Next, the pigment particle are dispersed in a slurry. Then the pigment particles in the slurry are added to a pigment pre-dispersion. Finally, the pigment particles can be dispersed in an ionomer composition. The mixing steps associated with forming each of these stages involve high shear forces. Because of the high shear forces, each mixing step further reduces the pigment particle sizes seen at each stage. This pigment particle size reduction at each level of processing is the reason why the compatible pigment particle size for a slurry is greater than the compatible pigment particle size for a pigment pre-dispersion. And similarly, why the compatible pigment particle size for a pigment pre-dispersion is greater than the compatible pigment particle size for an ionomer composition.

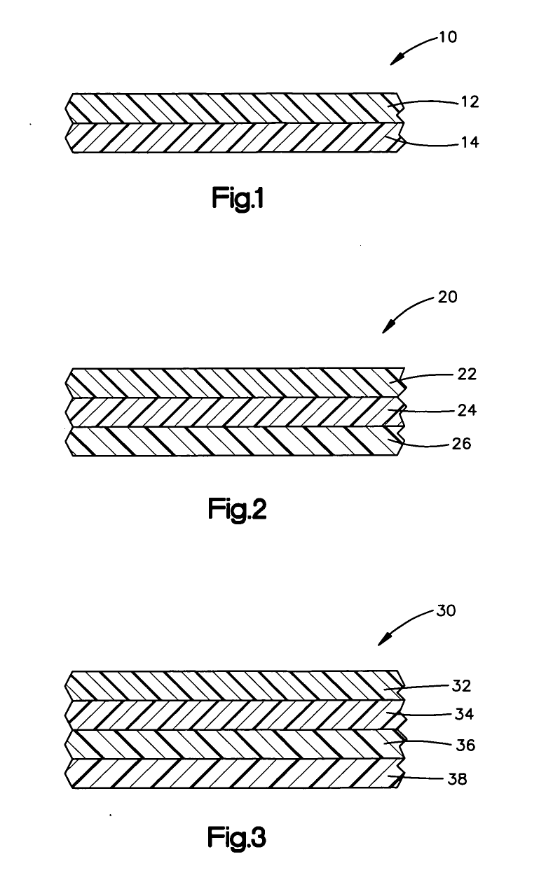

The pigmented ionomers can be used in multilayer films with other polymer layers. As shown in FIG. 1, a two-layer film 10 can have a first layer 12 and a second layer 14, wherein one of the layers is a pigmented ionomer and the other layer is a polymer. The polymer layer can be an ionomer film layer or a layer of one or more other polymer materials. For example, a pigmented ionomer layer can be combined with a clear ionomer layer to form a two layer film. As shown in FIGS. 2 and 3, a multilayer film also can include more than two layers. The additional layers may be ionomer materials or may be other polymer materials. The additional layers may be included to achieve specific physical requirements such as, for example, rigidity or weathering criteria. The multilayer film 20 shown in FIG. 2 comprises a first layer 22, a second layer 24, and a third layer 26, wherein one of the layers is a pigmented ionomer and the other layers comprise polymers. The multilayer film 30 shown in FIG. 3 comprises a first layer 32, a second layer 34, a third layer 36, and a fourth layer 38, wherein one of the layers is a pigmented ionomer and the other layers comprise polymers.

These multilayer films can be thermoformed into specific shaped parts such as, for example, an automobile bumper or other exterior trim panel. Such parts can be made from multilayer films that include layers that are thick enough to provide sufficient structural stability to be used alone, or the parts can be injection molded from behind with additional polymer material to provide support. The pigmented ionomers with their minimized pigment particle size, are able to maintain color uniformity and opacity in high draw regions created during thermoforming.

The multilayer films can be formed by co-extrusion. The layers of a co-extruded multi-layer film can include a pigmented ionomer layer that is co-extruded with ionomer film layers or layers of other polymer materials. For example the co-extruded pigmented ionomer layer can be a second layer and a co-extruded ionomer clear layer can be a first layer. A co-extruded third layer could be another ionomer layer or another polymer material. For example, the co-extruded third layer may be a glycidyl-methacrylate modified polypropylene derivative in which the glycidyl methacrylate may be grafted onto the polypropylene or the glycidyl methacrylate modified ethylene is physically cross-linked with a copolymer of polypropylene. The co-extruded third layer could also be a chlorinated polypropylene. Such modified polypropylenes exhibit excellent adhesion to co-extruded ionomer layers and also provide stiffness to products formed from the multilayer films, for example, by thermoforming.

These co-extruded multilayer films can include any number of layers to create a desired set of physical properties. Additional co-extruded layers can include, but are not limited to, polymers such as polypropylene, polypropylene copolymer, polyethylene, polyethylene copolymer, polyamide, polyester, ABS, styrene terpolymer, and polyurethane. These additional layers can include tie layers that bind the layers on either side of a tie layer together. Examples of co-extruded layers that can act as tie layers include, but are not limited to, polymers such as maleic anhydride grafted copolymers or terpolymers, acrylate modified ionomers or terpolymers, glycidal methacrylate copolymers or terpolymers, styrene copolymers and terpolymers such as SEBS, SIS, SAN, ABS, polyester polyurethane, polyether polyurethane, amorphous polyamide, ethylene-octene, butene, hexene, and mixtures thereof.

Pigmented ionomers, films made from pigmented ionomers, and multilayer films that include a pigmented ionomer layer as described herein may be exposed to various structure modifying treatments to further enhance aspects of physical performance. These products may, for example, be subjected to corona discharge treatment, ozone treatment, low temperature plasma treatment which incorporates either oxygen or nitrogen gas, glow plasma treatment, reverse sputtering treatment, oxidation treatment using chemicals, UV curing, e-beam irradiation, gamma beam irradiation, x-rays and the like. Such treatments may, among other things, cross-link the polymer , structure of the pigmented ionomers, films made from pigmented ionomers, and multilayer films that include a pigmented ionomer layer. As an example, the pigmented ionomers, films made from pigmented ionomers, and multilayer films that include a pigmented ionomer layer could be exposed to gamma beam, electron beam, or x-ray radiation at dosing levels of between 0.1 and 50 meg-rads. These treatments can improve the surface hardness, scratch resistance, mar resistance, chemical resistance and/or oxygen/air barrier efficiency of the pigmented ionomers while maintaining low haze, high gloss, transparency, and distinction of image. Additionally, weathering performance can be maintained or enhanced and material memory can be maintained. These treatments may also improve the adhesion properties of the pigmented ionomers to various substrates.

### EXAMPLE 1

A pigment pre-dispersion flush was created using a black pigment (Monarch® Black 1300, manufactured by Cabot Corporation, Billerica, Mass.) and an acid copolymer resin (Escor® 7010, manufactured by Exxon Mobil Corporation, Houston, Tex.). First a slurry was created by mixing 3337 grams of water, 1135 grams of black pigment, 11.4 grams of an antioxidant (Irganox® 1330, manufactured by Ciba Specialty Chemicals Corp., Tarrytown, N.Y.), and 56.75 grams of a rosin/dispersing aid (Silvatol, manufactured by Ciba Specialty Chemicals Corp., Tarrytown, N.Y.) in a Silverson Laboratory Mixer using a stainless steel mixing tank. Next, 667.5 grams of acid copolymer resin were melted in a Jet Mill over the course of one hour. Finally, 908 grams of the slurry was mixed into the melted acid copolymer resin in stages. In the first stage of the slurry mixing, 50% of the slurry was added to the melted acid copolymer resin. After about five minutes, the mixture “broke” and clear water from the slurry came off the melted acid copolymer resin. Once the mixture broke, the next 20% of the slurry was added to the melted acid copolymer resin. Again after about five minutes, the mixture broke and clear water came off the melted acid copolymer resin. Then, once this latest slurry addition broke, the next 20% of the slurry was added to the melted acid copolymer resin. This mixture broke after about five minutes. Finally, the last 10% of the slurry mixture was added to the melted acid copolymer resin. This final mixture broke in about five minutes.

After the final mixture broke, the melted acid copolymer resin was solidified. The acid copolymer resin was then ground for two hours. During grinding, the temperature reached 95-96° C. After grinding the ground acid copolymer resin was rinsed with water. Finally, the rinsed, ground, and pigmented acid copolymer resin was dried.

To analyze the pigment particle size of the pigment pre-dispersion, the pigment pre-dispersion was let down into an acid co-polymer (Escor 7010) at a 50% level. The pigment particle size of this pigment pre-dispersion was determined by evaluating the melt smear under a microscope. Three fields of views of the microscope (2 mm×2 mm) at 100× magnification were examined. The number and size of the agglomerates found in each field of view are shown in Table 3.

TABLE 3
Pigment Particle Sizes for Example 1

| Field of View | Agglomerate(s) |
|---|---|
| 1 | 1 @ 8 micrometers |
| 2 | 1 @ 5 micrometers |
| 3 | 2 @ 3-4 micrometers |

The pigment particle sizes of the pigment pre-dispersion of Example 1 as shown in Table 3 demonstrate an excellent pigment particle size level.

### EXAMPLE 2

The same experiment as Example 1 was run using an iron mixing tank with the Silverson Laboratory mixer. The dispersion results are shown in Table 4.

TABLE 4
Pigment Particle Sizes for Example 2

| Field of View | Agglomerate(s) |
|---|---|
| 1 | 1 @ >25 micrometers |
| 2 | 2 @ 20-25 micrometers |
| 3 | 3 @ 10-12 micrometers |

Example 2 does not exhibit the same quality with respect to pigment particle size as Example 1. The formation of larger agglomerates is believed to be due to the use of the iron mixing tank. Free ions are available in an iron mixing tank as compared to the stainless steel mixing tank used in Example 1. These available free ions can interact with the pigment particles or the carrier resin causing the formation of larger pigment agglomerates.

This written description sets forth the best mode of the invention, and describes the invention so as to enable a person skilled in the art to make and use the invention, by presenting examples of the elements recited in the claims. The patentable scope of the invention is defined by the claims, and may include other examples that occur to those skilled in the art. Such other examples, which may be available either before or after the application filing date, are intended to be within the scope of the claims if they have structural elements that do not differ from the literal language of the claims, or if they include equivalent structural elements with insubstantial differences from the literal language of the claims.

1. A method for making a pigment pre-dispersion composition for use with an ionomer comprising the steps of:
(a) creating a slurry of a pigment in water;
(b) melting or softening a resin compatible with an ionomer; and
(c) mixing the slurry into the melted or softened resin.

2. The method of claim 1, wherein the slurry has a pigment particle size of less than or equal to about 50 micrometers.

3. The method of claim 1, wherein the slurry has a pigment particle size of less than or equal to about 40 micrometers.

4. The method of claim 1, wherein the slurry has a pigment particle size of less than or equal to about 30 micrometers.

5. The method of claim 1, wherein the slurry has a pigment particle size of less than or equal to about 20 micrometers.

6. The method of claim 1, wherein the slurry has a pigment particle size of less than or equal to about 10 micrometers.

7. The method of claim 1, wherein the pigment particle size in the pigment pre-dispersion is less than about 30 micrometers.

8. The method of claim 1, wherein the pigment particle size in the pigment pre-dispersion is less than about 25 micrometers.

9. The method of claim 1, wherein the pigment particle size in the pigment pre-dispersion is less than about 20 micrometers.

10. The method of claim 1, wherein the pigment particle size in the pigment pre-dispersion is less than about 15 micrometers.

11. The method of claim 1, wherein the pigment particle size in the pigment pre-dispersion is less than about 10 micrometers.

12. The method of claim 1, wherein the pigment particle size in the pigment pre-dispersion is less than about 5 micrometers.

13. The method of claim 1, wherein the pigment pre-dispersion when melted will flow through a U.S. Mesh 400 screen.

14. The method of claim 1, wherein the resin that is compatible with the ionomer has a refractive index within about 0.005 of the refractive index of the ionomer when measured at the same temperature and load as the ionomer.

15. The method of claim 1, wherein the resin that is compatible with the ionomer has a melt flow index that is greater than the ionomer.

16. The film or sheet of claim 1, wherein the resin is an acid copolymer, acid terpolymer, ionomer, polyethylene, ethylene vinyl acetate, ethylene methylacrylate, or mixtures thereof.

17. A pigment pre-dispersion composition for use with an ionomer comprising:
a resin that is compatible with an ionomer; and
a pigment having a particle size that is less than about 30 micrometers.

18. The pigment pre-dispersion composition of claim 17, wherein the pigment particle size in the pigment pre-dispersion composition is less than about 25 micrometers.

19. The pigment pre-dispersion composition of claim 17, wherein the pigment particle size in the pre-dispersion pigment composition is less than about 20 micrometers.

20. The pigment pre-dispersion composition of claim 17, wherein the pigment particle size in the pre-dispersion pigment composition is less than about 15 micrometers.

21. The pigment pre-dispersion composition of claim 17, wherein the pigment particle size in the pre-dispersion pigment composition is less than about 10 micrometers.

22. The pigment pre-dispersion composition of claim 17, wherein the pigment particle size in the pre-dispersion pigment composition is less than about 5 micrometers.

23. The pigment pre-dispersion composition of claim 17, wherein the pre-dispersion pigment composition when melted will flow through a U.S. Mesh 400 screen.

24. The pigment pre-dispersion composition of claim 17, wherein the resin that is compatible with the ionomer has a refractive index within about 0.005 of the refractive index of the ionomer when measured at the same temperature and load as the ionomer.

25. The pigment pre-dispersion composition of claim 17, wherein the resin that is compatible with the ionomer has a melt flow index that is greater than the ionomer.

26. The pigment pre-dispersion composition of claim 17, wherein the resin is an acid copolymer, acid terpolymer, ionomer, polyethylene, ethylene vinyl acetate, ethylene methylacrylate, or mixtures thereof.

27. A melt blended composition comprising:
an ionomer;
a resin that is compatible with the ionomer; and
a pigment having a pigment particle size that is less than or equal to about 25 micrometers.

28. The melt blended composition of claim 27, wherein the pigment particle size in the melt blended composition is less than or equal to about 20 micrometers.

29. The melt blended composition of claim 27, wherein the pigment particle size in the melt blended composition is less than or equal to about 15 micrometers.

30. The melt blended composition of claim 27, wherein the pigment particle size in the melt blended composition is less than or equal to about 10 micrometers.

31. The melt blended composition of claim 27, wherein the pigment particle size in the melt blended composition is less than or equal to about 5 micrometers.

32. The melt blended composition of claim 27, wherein the resin that is compatible with the ionomer has a refractive index within about 0.005 of the refractive index of the ionomer when measured at the same temperature and load as the ionomer.

33. The melt blended composition of claim 27, wherein the resin that is compatible with the ionomer has a melt flow index that is greater than the ionomer.

34. The melt blended composition of claim 27, wherein the resin is an acid copolymer, acid terpolymer, ionomer, polyethylene, ethylene vinyl acetate, ethylene methylacrylate, or mixtures thereof.

35. A film or sheet formed from the melt blended composition of claim 27.

36. A multilayer film or sheet comprising:
a polymer layer; and
a pigmented ionomer layer comprising:
an ionomer;
a resin that is compatible with the ionomer; and
a pigment having a pigment particle size that is less than or equal to about 25 micrometers.

37. The multilayer film or sheet of claim 36, wherein the polymer layer and the pigmented ionomer layer are co-extruded.

38. The multilayer film or sheet of claim 36, wherein the polymer layer is a clear ionomer layer.

39. The multilayer film or sheet of claim 36, further comprising a third polymer layer in direct contact with the pigmented ionomer layer.

40. The multilayer film or sheet of claim 39, wherein the third polymer layer is a glycidyl-methacrylate modified polypropylene derivative.

41. The multilayer film or sheet of claim 40, wherein the glycidyl-methacrylate is grafted onto the polypropylene.

42. The multilayer film or sheet of claim 40, wherein the glycidyl-methacrylate modified ethylene is physically cross-linked with a copolymer of polypropylene.

43. The multilayer film or sheet of claim 39, wherein the third polymer layer is chlorinated polypropylene.

44. The multilayer film or sheet of claim 39, further comprising a fourth polymer layer in direct contact with the third polymer layer.

45. The multilayer film or sheet of claim 44, wherein the fourth polymer layer is selected from the group consisting of polypropylene, polypropylene copolymer, polyethylene, polyethylene copolymer, polyamide, polyester, ABS, styrene terpolymer, and polyurethane.

46. The multilayer film or sheet of claim 36, wherein the multilayer film or sheet is thermoformed into a part.

47. The multilayer film or sheet of claim 36, wherein the multilayer film or sheet is thermoformed into a part and then injection molded from behind.
